(19) United States
(12) Patent Application Publication
(10) Pub. No.: US 2015/0142188 A1
(43) Pub. Date: May 21, 2015

(54) Automated Commissioning of a Gas Turbine Combustion Control System

(71) Applicant: General Electric Company, Schenectady, NY (US)

(72) Inventors: Jason Charles Terry, Greenville, SC (US); Timothy Andrew Healy, Greenville, SC (US); David Kaylor Toronto, Greenville, SC (US)

(73) Assignee: General Electric Company, Schenectady, NY (US)

(21) Appl. No.: 14/086,593

(22) Filed: Nov. 21, 2013

(51) Int. Cl. G05B 15/02

(52) U.S. Cl. CPC G05B 15/02
USPC 700/287

(57) ABSTRACT

Systems and methods for automating commissioning of a gas turbine combustion control system are provided. According to one embodiment of the disclosure, a system may include a controller and a processor communicatively coupled to the controller. The processor may be configured to run a gas turbine under a plurality of operational conditions while within predetermined combustion operational boundaries. The processor may be further configured to automatically collect operational data associated with the gas turbine while the gas turbine is running and store the operational data. Based at least in part on the operational data, a set of constants for one or more predetermined combustion transfer functions is generated. The set of constants is stored in the gas turbine combustion control system to be used during auto-tune operations of the gas turbine.

### TECHNICAL FIELD

This disclosure relates generally to controllers for a combustion system of a gas turbine power plant and, more particularly, to systems and methods for automated commissioning of a gas turbine combustion control system.

### BACKGROUND

Industrial and power generation gas turbines can have one or more control systems (“controllers”) that monitor and control operations of the gas turbines. These controllers can govern overall operation of the gas turbine and the combustion process of the gas turbine in particular.

Since operation of a gas turbine may depend on specifics of a particular unit, location, or consumables, commissioning tests typically are performed during a commissioning procedure of the gas turbine. The commissioning tests can include running the gas turbine under various operating conditions, such as different loads and fuel splits, and collecting data associated with gas turbine performance under certain conditions. The collected data can be used to fine tune transfer functions associated with the gas turbine.

However, traditionally, such commissioning procedures are performed manually. Manual operations lack robustness and can cause errors. Moreover, the data obtained using these manual procedures may be incomplete and relatively difficult to interpret.

### BRIEF DESCRIPTION OF THE DISCLOSURE

The disclosure relates to systems and methods for automating commissioning of a gas turbine combustion control system. According to one embodiment of the disclosure, a method is provided. The method may include running a gas turbine under a plurality of operational conditions while within predetermined combustion operational boundaries. While the gas turbine is running, operational data associated with the gas turbine may be automatically collected. The collected data may be stored in a predefined location. Based at least in part on the operational data, a set of constants for one or more predetermined combustion transfer functions may be generated. The generated constants may be used to tune the combustion transfer functions. The set of constants may be stored in the gas turbine combustion control system to be used during the commissioning or tuning of the gas turbine.

In another embodiment of the disclosure, a system is provided. The system may include a controller and a processor in communication with the controller. The processor may be configured to run a gas turbine under a plurality of operational conditions while within predetermined combustion operational boundaries. While the gas turbine is running, the processor may automatically collect operational data associated with the gas turbine. The collected data may be stored by the processor in the gas turbine combustion control system, one or more databases, or other locations. Based at least in part on the operational data, the processor may generate a set of constants for one or more predetermined combustion transfer functions. The generated set of constants may be used during auto-tune operations of the gas turbine.

In yet another embodiment of the disclosure, a gas turbine power generation system is provided. The system may include a gas turbine, a controller in communication with the gas turbine, and a processor in communication with the controller. The controller may include a gas turbine combustion control system to control operation of a combustor being a part of the gas turbine. The processor may be configured to run the gas turbine under a plurality of operational conditions while within predetermined combustion operational boundaries. Additionally, the processor may be configured to automatically collect operational data associated with the gas turbine while the gas turbine is running. The collected data may be stored in the gas turbine combustion control system, one or more databases, and other locations. Furthermore, the processor may be configured to generate a set of constants for one or more predetermined combustion transfer functions based at least in part on the operational data. The set of constants may be used to adjust the transfer functions to correspond to the specifics of the gas turbine and the operational conditions. Additionally, the set of constants may be stored in the gas turbine combustion control system. The stored constants may be used during auto-tune operations of the gas turbine.

Other embodiments and aspects will become apparent from the following description taken in conjunction with the following drawings.

### BRIEF DESCRIPTION OF THE DRAWINGS

FIG. 1 is a block diagram illustrating an example environment and system for automating commissioning of a gas turbine combustion control system, in accordance with an embodiment of the disclosure.

FIG. 2 depicts a block diagram illustrating an example method for automating commissioning of a gas turbine combustion control system, in accordance with an embodiment of the disclosure.

FIG. 3 depicts a block diagram illustrating a detailed method for automating commissioning of a gas turbine combustion control system, in accordance with an embodiment of the disclosure.

FIG. 4 depicts an example emission transfer function tuned using a constant generated using a method for automating commissioning of a gas turbine combustion control system, in accordance with an embodiment of the disclosure.

FIG. 5 is a block diagram illustrating an example controller for controlling a power plant, in accordance with an embodiment of the disclosure.

### DETAILED DESCRIPTION

The following detailed description includes references to the accompanying drawings, which form part of the detailed description. The drawings depict illustrations, in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

Certain embodiments described herein relate to a system and methods for automated commissioning of a gas turbine combustion control system.

A gas turbine, also called a combustion gas turbine, is a type of internal combustion engine. It may include an upstream rotating compressor coupled to a downstream turbine and a combustion chamber in-between. The combustion gas turbine, like any other internal combustion engine, is a machine that converts the thermal energy of burning fuel into useful power, which in turn is converted into mechanical energy. The basic operation of the gas turbine is similar to that of the steam power plant except that air is used instead of water. Air flows through a compressor that brings it to a higher pressure. Energy is then added by spraying fuel into the air and igniting it so the combustion generates a high-temperature flow. This high-temperature high-pressure gas enters a turbine, where it expands down to the exhaust pressure, producing a shaft work output in the process. The turbine shaft work is used to drive the compressor and other devices such as an electric generator that may be coupled to the shaft. The energy that is not used for shaft work comes out in the exhaust gases, so these have either a high temperature or a high velocity. The purpose of the gas turbine determines the design so that the most desirable energy form can be maximized.

A combustor is a component or area of the gas turbine where combustion takes place. It is also known as a burner, combustion chamber, or flame holder. In the gas turbine engine, the combustor or combustion chamber can be fed high pressure air by the compression system. The combustor then heats this air at a constant pressure. After heating, air passes from the combustor through the nozzle guide vanes to the turbine. A combustor can contain and maintain stable combustion despite relatively high air flow rates. To do so, the combustor can be carefully designed to first mix and ignite the air and fuel, and then mix in more air to complete the combustion process. A combustor can play a crucial role in determining many of a turbine's operating characteristics, such as fuel efficiency, levels of emissions, and transient response (the response to changing conditions such as fuel flow and air speed).

Industrial gas turbines may include one or more control systems (controllers) that monitor and control their operation. These controllers can govern the combustion system of the gas turbine and other operational aspects of the turbine. Thus, a controller may execute scheduling algorithms that adjust the fuel flow, combustor fuel splits (i.e., the division of the total fuel flow into the gas turbine between the various fuel circuits of the turbine), angle of the inlet guide vanes (IGVs), and other control inputs to ensure safe and efficient operation of the gas turbine. The controller can schedule the fuel splits for the combustor to maintain the desired combustion mode (e.g., part-load total fuel flow) and operate the gas turbine within established operational boundaries, such as for combustion dynamics.

Combustion dynamics may refer to the combustion process inside a combustion “can” and “liner.” When fuel is burned, there is a pressure increase, and depending on the design of the combustor, the fuel nozzles, the liner, and other components, the combustion process can be smooth or it can be subject to pressure oscillations or pulsations. These oscillations or pulsations, if not minimized, can lead to premature failure of combustion components as well as unstable flame. When fuel is burning in a combustion turbine, there may be relatively high air flows and this may cause turbulence. The turbulence may be desirable to achieve good mixing with the fuel for efficient combustion, but not desirable because it can lead to high pressure oscillations/pulsations. Some pressure oscillations or pulsations can be similar to pressure pulsations in a pipe or vibrations and can be “exaggerated” at some points to the point of becoming destructive. The oscillations or pulsations may have resonance or resonant frequencies that need to be attenuated or avoided. For some combustion systems, especially those with lean fuel/air ratios, it can be very difficult to achieve a balance of stable combustion, stable “flame,” low dynamics (pressure oscillations/pulsations), and low emissions (which is the purpose of lean fuel/air ratios in combustion turbines).

Combustor fuel splits may be set according to a nominal fuel split scheduling algorithm, which may be driven by a calculated combustion reference temperature (TTRF). The values of the TTRF may be calculated using various measured parameters, such as compressor discharge pressure, turbine exhaust temperature, exhaust air flow, ambient temperature, and inlet guide vane angles, as inputs. During part-load operation, the combustor fuel splits can greatly influence the production of harmful emissions, such as carbon-monoxide (CO) and nitrogen-oxide (NOx). Burning a lean premixed flame can keep NOx emissions low but can result in acoustic instability in the gas turbine. In time this instability (combustor dynamics) can damage components in the combustion chamber (nozzles, liners, transition pieces) and/or downstream components (turbine nozzles and blades), causing unnecessary downtime, increased equipment repair costs, and loss of generating revenue. Thus, suitable scheduling of the fuel splits can help maintain NOx and CO compliance, flame stability, and suitable combustion dynamics.

Controlling and tuning combustion in a gas turbine can be increasingly important with implementation of fuel staging and lean premixed combustor systems, and tuning is becoming more complex and important because of related instability and other issues. However, conventional methods of unit commissioning can be complex, prone to errors, and lack rigor and robustness.

Using certain embodiments of the systems and methods described herein, an automated commissioning procedure for the gas turbine combustion control system can be implemented to replace conventional manual procedures. During the commissioning, the gas turbine can be run under various operational conditions, including various combustor temperatures, airflows, fuel flows, and so forth. The gas turbine can be kept within predetermined combustion operational boundaries while performing such test runs. The operational boundaries may include emissions, dynamics, lean blow-out, and the like. Operational data associated with the gas turbine running various operational conditions may be automatically collected and stored. Based on the collected data, a set of constants for predetermined transfer functions can be generated. The set of constants may be used to tune the predetermined transfer functions based at least in part on the collected data. The constants may be stored in the gas turbine combustion control system as well as loaded in the controller of the gas turbine and, after some verifications, used for power plant operation.

Thus, according to at least one embodiment of a system and method for automating commissioning of a gas turbine combustion control system, an automated, fully customizable solution can be provided to achieve customer-determined operational objectives, while continually monitoring and adjusting key combustion control parameters to maintain NOx and CO compliance, flame stability, and acceptable combustion dynamics. Gas turbine operators may gain extensive benefits by controlling gas turbine operation without third-party input. Specific gas turbine operating information, which can affect gas turbine optimization, can be housed on-site and adjusted in-house.

The technical effects of certain embodiments of the disclosure may include eliminating errors resulting from manual procedures as well as providing robustness and rigor for the commissioning procedure. Further technical effects of certain embodiments of the disclosure may include optimizing commissioning of a gas turbine through automation and standardization of the procedures associated with the commissioning. The automated commissioning improves combustion dynamics control and emissions management. Additionally, providing a robust storage for the data obtained in the commission or re-tuning processes enables continual optimization of the commissioning and operation of a gas turbine.

The following provides the detailed description of various example embodiments related to systems and methods for automating commissioning of a gas turbine combustion control system.

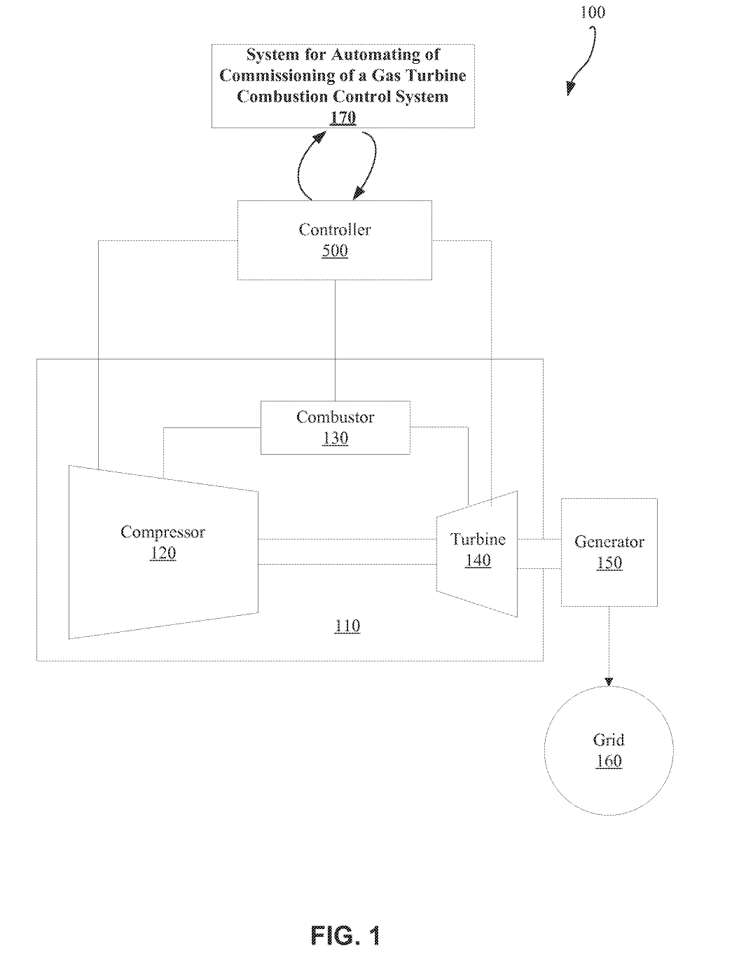

Referring now to FIG. 1, a block diagram illustrates an example system environment 100 suitable for implementing methods and systems for automating commissioning of a gas turbine combustion control system, in accordance with one or more example embodiments. In particular, the system environment 100 may include a gas turbine 110 with a compressor 120, a combustor 130, a turbine 140 coupled to the compressor 120, and a controller 500. The gas turbine 110 may drive a generator 150 that produces electrical power and supplies the electrical power via a breaker to an electrical grid 160.

In some embodiments, the combustor 130 may include lean premixed combustors or ultra-low emission combustors which may use air as a diluent. In such a way, combustion flame temperatures may be reduced. Additionally, premixing fuel and air before they enter the combustor reduces NOx emission. An example ultra-low emission combustor may be a dry low NOx (DLN) combustor.

Gas turbine engines with ultra-low emissions combustors, e.g., DLN combustion systems, require precise control so that the turbine gas emissions are within limits established by the turbine manufacturer, and to ensure that the gas turbine operates within certain operability boundaries (e.g., lean blowout, combustion dynamics, and other parameters). Control systems for ultra-low emission combustors generally need relatively accurate and calibrated emission sensors. The compressor 120, combustor 130, and turbine 140 may be coupled to the controller 500. The operation of the gas turbine 110 may be managed by the controller 500. The controller 500 may include a computer system having a processor(s) that executes programs to control the operation of the gas turbine 110 using sensor inputs, transfer function outputs, and instructions from human operators. The controller 500 may include a gas turbine combustion control system and may be configured to manage combustion during turbine operation.

The operation of the gas turbine 110 may need the controller 500 to set total fuel flow, compressor IGV, inlet bleed heat (IBH), and combustor fuel splits to achieve a desired cycle match point (i.e., generate a desired output and heat-rate while observing operational boundaries). The total fuel flow and IGV position can be effectors in achieving a desired result. A typical part-load control mode can involve setting fuel flow and the IGV angle to satisfy the load (generator output) request, and to observe an exhaust temperature profile (temperature control curve). When base-load operation is achieved, the IGV is typically at an angle of maximum physical limit. At base-load, fuel flow alone can generally be adjusted to observe an exhaust temperature profile needed to satisfy emission limits and other gas turbine operating limits.

In certain embodiments, the gas turbine 110 may include a fuel controller (not shown). The fuel controller may be configured to regulate the fuel flowing from a fuel supply to the combustor 130. The fuel controller may also select the type of fuel for the combustor 130. Additionally, the fuel controller may also generate and implement fuel split commands that determine the portion of fuel flowing to the various fuel circuits of the combustor 130. Generally, the fuel split commands may correspond to a fuel split percentage for each fuel circuit, which defines what percentage of the total amount of fuel delivered to the combustor 130 is supplied through a particular fuel circuit. It should be appreciated that the fuel controller may comprise a separate unit or may be a component of the controller 500.

According to further embodiments, the operation of the gas turbine 110 may be monitored by one or more sensors detecting various conditions of the gas turbine 110, generator 160, and sensing parameters of the environment. For example, temperature sensors may monitor ambient temperature surrounding the gas turbine 110, compressor discharge temperature, turbine exhaust gas temperature, and other temperature measurements of the gas stream through the gas turbine 110. Pressure sensors may monitor ambient pressure, static and dynamic pressure levels at the compressor inlet and outlet, and turbine exhaust, as well as at other locations in the gas stream. Further, humidity sensors (e.g., wet and dry bulb thermometers) may measure ambient humidity in the inlet duct of the compressor. The sensors may also include flow sensors, speed sensors, flame detector sensors, valve position sensors, guide vane angle sensors, or the like that sense various parameters pertinent to the operation of gas turbine 110. As used herein, the term “operational conditions” refer to fuel splits, loads, and other conditions applied for turbine operation, while “operational data” and similar terms refer to items that can be used to define the affecting parameters of the gas turbine 110, such as temperatures, pressures, and flows at defined locations in the gas turbine 110 that can be used to represent dependencies between reference conditions and the gas turbine response. In certain example embodiments, emission sensors may be provided to measure emissions levels in a turbine exhaust and provide feedback data used by control algorithms. For example, emissions sensors at the turbine exhaust provide data on current emissions levels that may be applied in determining a turbine exhaust temperature request.

The controller 500 may interact with a system 170 for automating commissioning of a gas turbine combustion control to transfer commands to perform under specific operational conditions to the gas turbine 110 and the corresponding operational data from the sensors and the gas turbine to the system 170.

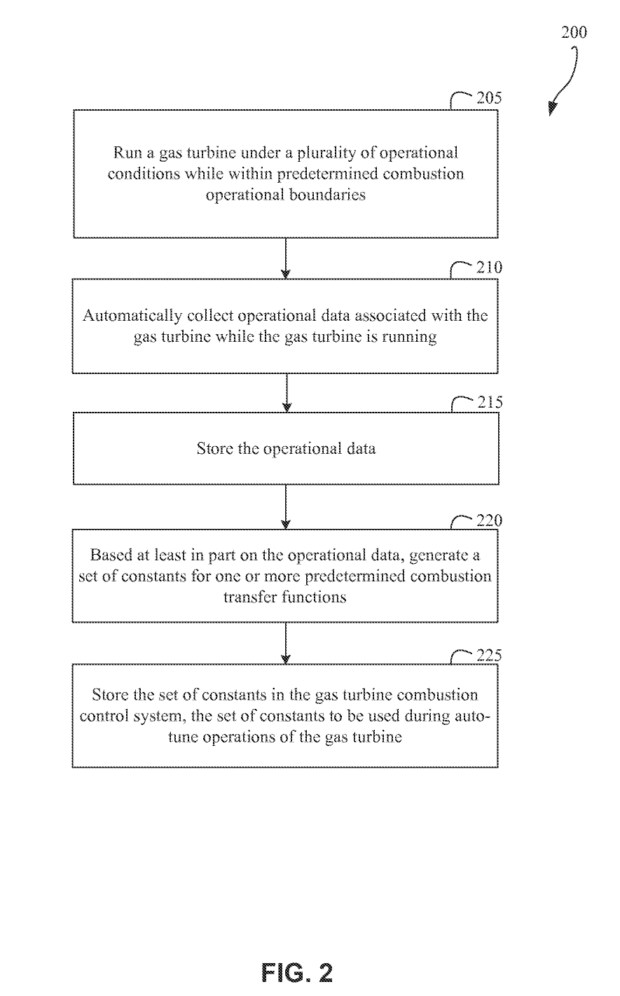

FIG. 2 depicts a process flow diagram illustrating an example method 200 for automating commissioning of a gas turbine combustion control system, in accordance with an embodiment of the disclosure. The method 200 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the controller 500, which may reside in a user device or in a server. It will be appreciated that instructions to be executed by the controller 500 may be retrieved and executed by one or more processors. The controller 500 may also include memory cards, servers, and/or computer discs. Although the controller 500 may be configured to perform one or more steps described herein, other control units may be utilized while still falling within the scope of various embodiments.

As shown in FIG. 2, the method 200 may commence in operation 205 with running a gas turbine under a plurality of operational conditions while within predetermined combustion operational boundaries. When the gas turbine is commissioned, re-commissioned, re-tuned, or otherwise readjusted, one or more test procedures may be performed on the gas turbine. During the test procedure, the turbine may be run with various fuel splits and loads according to one or more scheduling algorithms. While the test procedures are performed, the control parameters of the turbine, such as dynamics, stability, and emissions, may be continuously monitored and adjusted to keep them within the operational boundaries. The scheduling algorithms may generally enable a controller of the gas turbine to maintain, for example, the NOx and CO emissions in the turbine exhaust to within certain predefined emission limits, and to maintain the combustor firing temperature to within predefined temperature limits. Thus, it should be appreciated that the scheduling algorithms may use various operating parameters as inputs. The controller may then apply the algorithms to schedule the gas turbine, for example, to set desired turbine exhaust temperatures and combustor fuel splits, so as to satisfy performance objectives while complying with operational boundaries of the turbine.

Operational data of the turbine performing the test procedures may be automatically collected at operation 210. The operational data may be real-time sensed and measured by one or more sensors or calculated by the controller. The operational data may include an inlet temperature, airflow, fuel flow, inlet pressure, exhaust pressure, exhaust temperature, compressor discharge pressure, compressor discharge temperature, turbine power, ambient pressure, humidity, field manifold pressure, exhaust ignition, and so forth. For example, combustor airflows and some temperatures may be calculated using an online aerothermal model. Temperature sensors may monitor compressor discharge temperature, turbine exhaust gas temperature, and other temperature measurements of the gas stream through the gas turbine. Pressure sensors may monitor static and dynamic pressure levels at the compressor's inlet and outlet, turbine exhaust, as well as at other locations in the gas stream. The sensors may also comprise flow sensors, speed sensors, flame detector sensors, valve position sensors, guide vane angle sensors, or the like that sense various conditions pertinent to the operation of gas turbine.

In operation 215, the collected operational data may be stored along with any prior data to one or more of a database and/or controller. For example, the data may be recorded to a spreadsheet. Data storage location and the data to be stored may be standardized, thus facilitating data finding and keeping of the data for future uses and historical analysis.

In operation 220, the operational data may be processed to generate a set of constants for one or more predetermined combustion transfer function forms. The transfer function forms may be fit with the operational data to get the set of constants for tuning of the transfer function forms. For example, a best-fit regression analysis may be used for this purpose. The best-fit regression analysis is most often used for prediction. One goal in regression analysis is to create a mathematical model that can be used to predict the values of a dependent variable based upon the values of an independent variable. In one example embodiment, a best-fit regression analysis may be performed using the operational data to generate the set of constants. The set of constants may be further used to obtain a set of transfer function outputs that provide the relatively closest predictions to the data.

The set of constants may represent specific weights used to adjust standard transfer functions to reflect specifics of the gas turbine performance. By applying the weights, predictions of combustor responses to various machine variations may be enabled. In operation 225, the set of constants may be stored in the gas turbine combustion control system. The set of constants may be used when commissioning the gas turbine and when changes are introduced to machine operation, controls, or hardware.

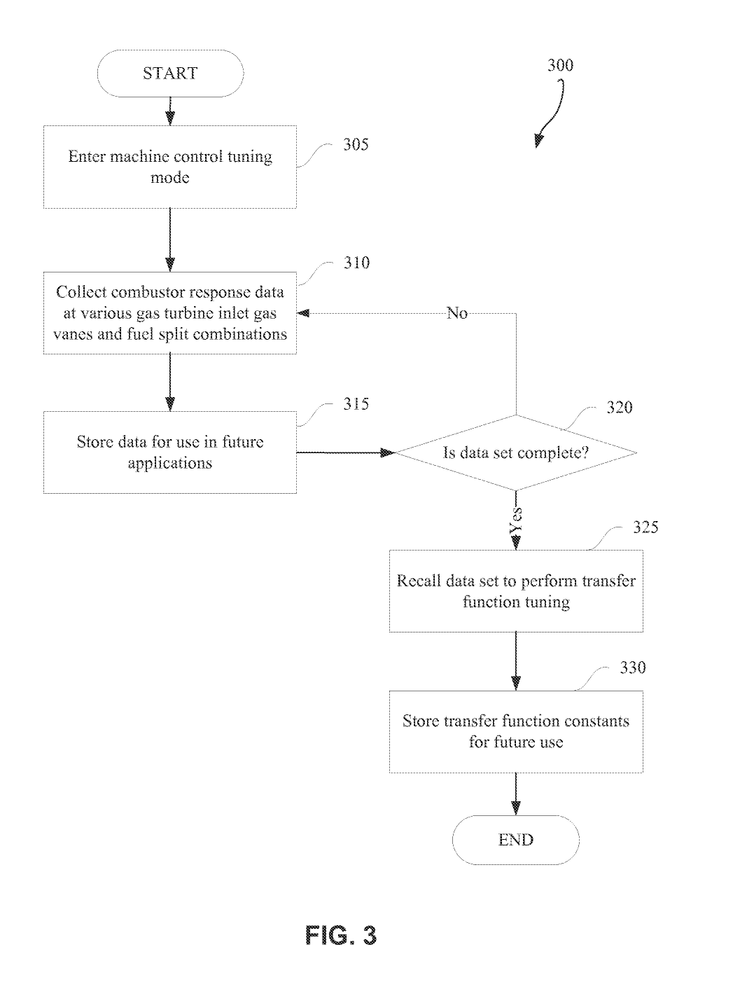

FIG. 3 depicts a process flow diagram illustrating an example detailed method 300 for automating commissioning of a gas turbine combustion control system, in accordance with an embodiment of the disclosure. When a gas turbine is commissioned, the combustor control system may enter a machine control tuning mode in operation 305. In the tuning mode, gas turbine parameters that are out of tune may be identified and corrected to stay within operational boundaries.

During the tuning, various operational conditions may be examined. One or more combinations of fuel splits and IGV positions may be tried, and the gas turbine response for each combination may be monitored and recorded. At that point, the compliance with the operational boundaries may be controlled. If some operational boundaries are violated, the operational conditions may be adjusted so that the corresponding turbine parameters return within the boundaries.

The operational boundaries may include emission, combustion instability, lean blowout boundary, combustor dynamics, fuel supply pressure, temperature, service life, bottoming cycle specifications, and the like. For example, the operational boundaries may relate to maintaining NOx and CO emissions in the turbine exhaust within certain predefined limits, keeping the combustor firing temperature within predefined temperature limits, and so forth.

The combustor response data associated with various operational conditions may be collected in operation 310. The combustor response data may include real-time calculated and measured machine operational data, such as an inlet temperature, airflow, fuel flow, inlet pressure, exhaust pressure, exhaust temperature, compressor discharge pressure, compressor discharge temperature, turbine power, ambient pressure, humidity, field manifold pressure, exhaust ignition, and the like.

The one or more transfer functions may be stored in a memory of the controller within the turbine control system. The transfer functions may be used to force the turbine to operate within certain limits, usually to avoid worst-case scenarios. There may be a separate combustor transfer function for each of the operating boundaries of the turbine. For example, there may be a combustor transfer function associated with emissions, LBO (lean blow out), dynamics, temperature, supply pressure, and the like.

The collected data may be stored for use in future applications in operation 315. The data may be stored in the controller together with any prior data. The prior data may be obtained from previous tuning procedures, for example, associated with changes to one of machine operation modes, changing of controls on the machine, changes to hardware, or refurbishing of hardware. The combined data may be used in future tuning procedures to make tuning more accurate and to determine possible trends or changes in the machine response.

In operation 320, it may be determined whether the data set is complete and if all data to fit transfer functions has been received. If it is determined that the data set is not complete, the method may continue with the operation 310 until the data set is complete. In operation 325, the data may be recalled to perform transfer function tuning. A best-fit regression analysis may be performed using the data to determine a set of constants that provide a set of transfer function outputs. The set of constants may be applied to get the closest predictions to the data.

In operation 330, the transfer function constants may be stored in the controller to be used during auto-tune operations as well as to be available to design engineers for use in machine predictions of combustor responses to various machine variations (e.g., load path modifications, control curve updates, steam temperature matching predictions, and so forth).

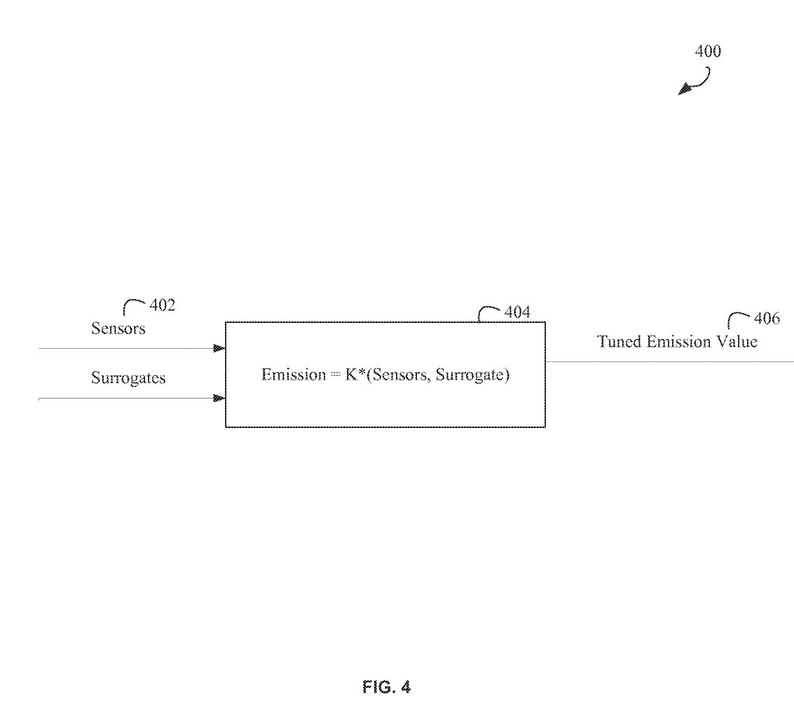

FIG. 4 depicts a process block diagram illustrating applying a tuning constant to an example transfer function, in accordance with an embodiment of the disclosure. The set of constants may be applied to one or more transfer functions to tune the operation of a gas turbine. One such transfer function may be an emission transfer function 404. The emissions transfer function 404 can receive data from sensors 402 and surrogates inputs. For example, the input data may include compressor discharge temperature, specific humidity of ambient air, fuel split ratio firing temperature, and so forth. The transfer function 404 can model the relationship between emissions and the cycle match point of the gas turbine. The sensors 402 used to generate the sensor data and the surrogates data for the emissions transfer function may be conventional sensors, e.g., temperature pressure and specific humidity sensors, that are typically used with a gas turbine and which are typically triple redundant.

A constant K may be generated as a result of the tuning procedure, and the emission transfer function 404 may be tuned using the constant K. Due to the constant K used by the emission transfer function 404, the function output is a tuned emission value 406.

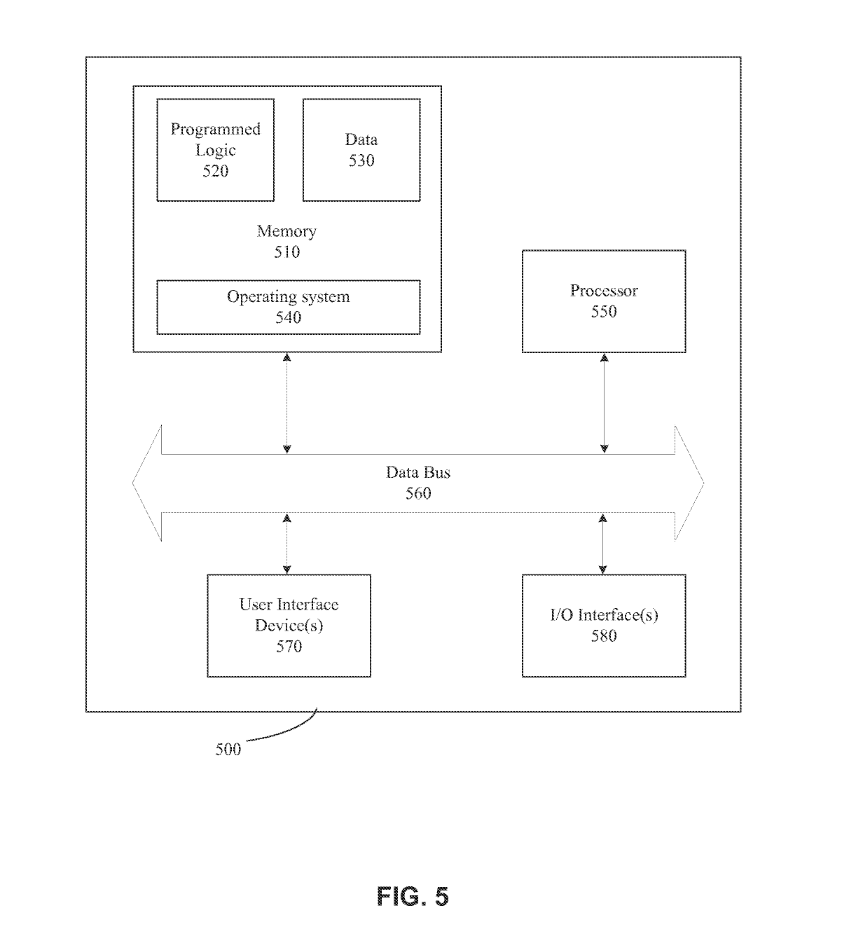

FIG. 5 depicts a block diagram illustrating an example controller 500 for automating commissioning of a gas turbine combustion control system, in accordance with an embodiment of the disclosure. More specifically, the elements of the controller 500 may be used to run a gas turbine under a plurality of operational conditions while within predetermined combustion operational boundaries, automatically collect operational data associated with the gas turbine while the gas turbine is running, store the operational data, generate a set of constants for one or more predetermined combustion transfer functions based on the operational data, and store the set of constants in the gas turbine combustion control system to be used during the commissioning of the gas turbine. The controller 500 may include a memory 510 that stores programmed logic 520 (e.g., software) and may store data 530, such as operational data associated with the gas turbine, the set of constants, and the like. The memory 510 also may include an operating system 540.

A processor 550 may utilize the operating system 540 to execute the programmed logic 520, and in doing so, may also utilize the data 530. A data bus 560 may provide communication between the memory 510 and the processor 550. Users may interface with the controller 500 via at least one user interface device 570, such as a keyboard, mouse, control panel, or any other device capable of communicating data to and from the controller 500. The controller 500 may be in communication with the gas turbine combustion control system online while operating, as well as in communication with the gas turbine combustion control system offline while not operating, via an input/output (I/O) interface 580. Additionally, it should be appreciated that other external devices or multiple other gas turbines or combustors may be in communication with the controller 500 via the I/O interface 580. In the illustrated embodiment, the controller 500 may be located remotely with respect to the gas turbine; however, it may be co-located or even integrated with the gas turbine. Further, the controller 500 and the programmed logic 520 implemented thereby may include software, hardware, firmware, or any combination thereof. It should also be appreciated that multiple controllers 500 may be used, whereby different features described herein may be executed on one or more different controllers 500.

Accordingly, certain embodiments described herein can alleviate complexity and susceptibility to errors of gas turbine commissioning methods. The commissioning may be facilitated by automating the tuning process by utilizing combustion transfer functions and real-time calculated and measured gas turbine operating conditions to obtain, store, and use gas turbine data to automatically commission a combustion control system. The disclosed methods and systems may standardize and reduce errors in the conventional autotune commissioning process. Additionally, the disclosed methods provide a more standard method for storing the data and a robust storage of the data obtained in the commission or re-tuning process as well as a more reliable method for remote commissioning.

References are made to block diagrams of systems, methods, apparatuses, and computer program products according to example embodiments. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A method for automating commissioning of a gas turbine combustion control system, the method comprising:
running a gas turbine under a plurality of operational conditions while within predetermined combustion operational boundaries;
automatically collecting operational data associated with the gas turbine while the gas turbine is running;
storing the operational data;
based at least in part on the operational data, generating a set of constants for one or more predetermined combustion transfer functions; and
storing the set of constants in the gas turbine combustion control system, the set of constants to be used during auto-tune operations of the gas turbine.

2. The method of claim 1, wherein the operational data comprises the following calculated or measured machine operating conditions: an inlet temperature, airflow, fuel flow, inlet pressure, exhaust pressure, exhaust temperature, compressor discharge pressure, compressor discharge temperature, turbine power, ambient pressure, humidity, field manifold pressure, and exhaust ignition.

3. The method of claim 1, wherein the combustion operational boundaries comprise one or more of emissions, dynamics, lean blow off, and nitric oxides emission.

4. The method of claim 1, wherein the generating the set of constants comprises performing a best-fit regression based at least in part on the operational data.

5. The method of claim 1, wherein the set of constants is used to enable predictions of combustor responses to various machine variations.

6. The method of claim 1, wherein the plurality of operational conditions includes a plurality of fuel splits and a plurality of loads.

7. The method of claim 1, wherein the set of constants for one or more predetermined combustion transfer functions corresponds to the operational data resulting in a desirable response of the gas turbine.

8. The method of claim 7, wherein selecting of the desirable response is based at least in part on combustion stability, dynamics, and emissions.

9. A system for automating commissioning of a gas turbine combustion control system, the system comprising:
a controller;
a processor communicatively coupled to the controller and configured to:
run a gas turbine under a plurality of operational conditions while within predetermined combustion operational boundaries;
automatically collect operational data associated with the gas turbine while the gas turbine is running;
store the operational data;
based at least in part on the operational data, generate a set of constants for one or more predetermined combustion transfer functions; and
store the set of constants in the gas turbine combustion control system, the set of constants to be used during auto-tune operations of the gas turbine.

10. The system of claim 9, wherein the operational data comprises the following calculated or measured machine operating conditions: an inlet temperature, airflow, fuel flow, inlet pressure, exhaust pressure, exhaust temperature, compressor discharge pressure, compressor discharge temperature, turbine power, ambient pressure, humidity, field manifold pressure, and exhaust ignition.

11. The system of claim 9, wherein the combustion operational boundaries comprise one or more of emissions, dynamics, lean blow off, and nitric oxides emission.

12. The system of claim 9, wherein the generating the set of constants comprises performing a best-fit regression based at least in part on the operational data.

13. The system of claim 9, wherein the set of constants is used to enable predictions of combustor responses to various machine variations.

14. The system of claim 9, wherein the plurality of operational conditions include a plurality of fuel splits and a plurality of loads.

15. The system of claim 9, wherein the set of constants for one or more predetermined combustion transfer functions corresponds to the operational data resulting in a desirable response of the gas turbine.

16. The system of claim 9, wherein the gas turbine combustion control system is associated with one or more ultra-low emission combustors.

17. A gas turbine power generation system, the system comprising:
a gas turbine;
a controller in communication with the gas turbine, wherein the controller includes a gas turbine combustion control system; and
a processor in communication with the controller and configured to:
run the gas turbine under a plurality of operational conditions while within predetermined combustion operational boundaries;
automatically collect operational data associated with the gas turbine while the gas turbine is running;
store the operational data;
based at least in part on the operational data, generate a set of constants for one or more predetermined combustion transfer functions; and
store the set of constants in the gas turbine combustion control system, the set of constants to be used during auto-tune operations of the gas turbine.

18. The gas turbine power generation system of claim 17, wherein the generating the set of constants comprises performing a best-fit regression based at least in part on the operational data.

19. The gas turbine power generation system of claim 17, wherein the processor is further configured to auto-tune operations of the gas turbine based at least in part on the set of constants.

20. The gas turbine power generation system of claim 17, wherein the set of constants for one or more predetermined combustion transfer functions corresponds to the operational data resulting in a desirable response of the gas turbine.
